(19) United States
(12) Patent Application Publication
(10) Pub. No.: US 2022/0208213 A1
(43) Pub. Date: Jun. 30, 2022

(54) INFORMATION PROCESSING DEVICE, INFORMATION PROCESSING METHOD, AND STORAGE MEDIUM

(71) Applicant: HONDA MOTOR CO., LTD., Tokyo (JP)

(72) Inventor: Kazuya Watanabe, Tokyo (JP)

(21) Appl. No.: 17/557,311

(22) Filed: Dec. 21, 2021

(30) Foreign Application Priority Data
Dec. 28, 2020 (JP) 2020-218189

(51) Int. Cl. G10L 25/51; G10L 15/26; G10L 15/02; G06F 40/289; G06F 40/242

(52) U.S. Cl. CPC G10L 25/51; G10L 15/26; G06F 40/242; G06F 40/289; G10L 15/02

(57) ABSTRACT

An information processing device of an embodiment. includes an extractor configured to extract a feature of a unique utterance from an utterance of a user on the basis of an utterance history of the user for a voice user interface and an estimator configured to estimate a proficiency level of the user for the voice user interface on the basis of the feature extracted by the extractor.

### CROSS-REFERENCE TO RELATED APPLICATION

This application is based upon and claims the benefit of priority from Japanese Patent Application No. 2020-218189, filed Dec. 28, 2020, the entire content of which is incorporated herein by reference.

### BACKGROUND

### Field of the Invention

The present invention relates to an information processing device, an information processing method, and a storage medium.

### Description of Related Art

A voice user interface using speech recognition technology and its related technology are known (see, for example, Japanese Unexamined Patent Application, First Publication No. H7-219582, Japanese Unexamined Patent Application, First Publication No. 2019-079187, and Japanese Unexamined Patent Application, First Publication No. 2015-041317).

### SUMMARY

However, in the conventional technology, it is difficult to customize functions of a voice user interface sufficiently in accordance with the experience of use of the voice user interface of each user, characteristics of each user, or the like, and the convenience of the voice user interface may not be sufficient.

Aspects of the present invention have been made in consideration of such circumstances and an objective of the present invention is to provide an information processing device, an information processing method, and a storage medium capable of implementing a more user-friendly (more convenient) voice user interface.

An information processing device, an information processing method, and a storage medium according to the present invention adopt the following configurations.

(1) According to a first aspect of the present invention, there is provided an information processing device including: an extractor configured to extract a feature of a unique utterance from an utterance of a user on the basis of an utterance history of the user for a voice user interface; and an estimator configured to estimate a proficiency level of the user for the voice user interface on the basis of the feature extracted by the extractor.

(2) According to a second aspect of the present invention, in the information processing device according to the first aspect, the feature of the unique utterance includes a subject, a predicate, or a sentence included in the unique utterance.

(3) According to a third aspect of the present invention, in the information processing device according to the first or second aspect, the feature of the unique utterance includes a speed of the unique utterance relative to a speed of a normal utterance.

(4) According to a fourth aspect of the present invention, the information processing device according to any one of the first to third aspects further includes a speech recognizer configured to textualize the utterance of the user using speech recognition; a natural language processor configured to understand a meaning of the utterance of the user textualized by the speech recognizer using natural language understanding; and a first determiner configured to determine an amount of data in at least one of a first dictionary used in the speech recognition and a second dictionary used in the natural language understanding on the basis of the proficiency level estimated by the estimator.

(5) According to a fifth aspect of the present invention, in the information processing device according to the fourth aspect, the first determiner decreases the amount of data in the first dictionary when the proficiency level is greater than or equal to a threshold value as compared with when the proficiency level is less than the threshold value.

(6) According to a sixth aspect of the present invention, in the information processing device according to the fourth or fifth aspect, the second dictionary includes a domain dictionary in which a plurality of domains that are classification for one or more entities are mutually associated, and the first determiner increases an amount of data in the domain dictionary when the proficiency level is greater than or equal to the threshold value as compared with when the proficiency level is less than the threshold value.

(7) According to a seventh aspect of the present invention, in the information processing device according to any one of the fourth to sixth aspects, the estimator further estimates an affinity of the user for the voice user interface on the basis of the feature extracted by the extractor, and the first determiner determines an amount of data in at least one of the first dictionary and the second dictionary on the basis of the proficiency level and the affinity estimated by the estimator.

(8) According to an eighth aspect of the present invention, in the information processing device according to the seventh aspect, the second dictionary includes an entity dictionary in which a plurality of entities are mutually associated, the first determiner increases an amount of data in the entity dictionary in a second case where the proficiency level is greater than or equal to a first threshold value and the affinity is greater than or equal to a second threshold value as compared with a first case where the proficiency level is less than the first threshold value and the affinity is greater than or equal to the second threshold value, and the first determiner increases the amount of data in the entity dictionary in a third case where the proficiency level is less than the first threshold value and the affinity is less than the second threshold value as compared with the second case.

(9) According to a ninth aspect of the present invention, the information processing device according to any one of the fourth to eighth aspects further includes a provider configured to provide setting guidance information of a dictionary determined by the first determiner to a terminal device of the user.

(10) According to a tenth aspect of the present invention, in the information processing device according to any one of the first to ninth aspects, the estimator further estimates an affinity of the user with respect to an utterance associated with the voice user interface on the basis of the feature extracted by the extractor, and the information processing device further includes a second determiner configured to determine a frequency of assistance via an utterance of the voice user interface on the basis of the proficiency level and the affinity estimated by the estimator.

(11) According to an eleventh fifth aspect of the present invention, in the information processing device according to the tenth aspect, the second determiner increases the frequency of assistance in a second case where the proficiency level is less than a first threshold value and the affinity is greater than or equal to a second threshold value as compared with a first case where the proficiency level is greater than or equal to the first threshold value and the affinity is greater than or equal to the second threshold value, and the second determiner increases the frequency of assistance in a third case where the proficiency level is less than the first threshold value and the affinity is less than the second threshold value as compared with the second case.

(12) According to a twelfth aspect of the present invention, in the information processing device according to the tenth or eleventh aspect, the estimator further estimates a second affinity of the user with respect to the utterance of the voice user interface on the basis of the feature extracted by the extractor, and the second determiner determines a frequency of utterance of the voice user interface with respect to the user on the basis of the second affinity estimated by the estimator.

(13) According to a thirteenth aspect of the present invention, in the information processing device according to the twelfth aspect, the second determiner increases the frequency of utterance when the second affinity is greater than or equal to a third threshold value as compared with when the second affinity is less than the third threshold value.

(14) According to a fourteenth aspect of the present invention, the information processing device according to any one of the tenth to thirteenth aspects further includes a provider configured to provide setting guidance information of a dictionary determined by the second determiner to a terminal device of the user.

(15) According to a fifteenth aspect of the present invention, there is provided an information processing method including: extracting, by a computer, a feature of a unique utterance from an utterance of a user on the basis of an utterance history of the user for a voice user interface; and estimating, by the computer, a proficiency level of the user for the voice user interface on the basis of the extracted feature.

(16) According to a sixteenth aspect of the present invention, there is provided a computer-readable non-transitory storage medium storing a program for causing a computer to: extract a feature of a unique utterance from an utterance of a user on the basis of an utterance history of the user for a voice user interface; and estimate a proficiency level of the user for the voice user interface on the basis of the extracted feature.

According to the above aspect, a more user-friendly voice user interface can be implemented.

### BRIEF DESCRIPTION OF THE DRAWINGS

FIG. 1 is a configuration diagram of an information providing system of an embodiment.

FIG. 2 is a diagram for describing content of user authentication information.

FIG. 3 is a diagram for describing content of utterance history information.

FIG. 4 is a diagram for describing content of VUI setting information.

FIG. 5 is a configuration diagram of a communication terminal of the embodiment.

FIG. 6 is a diagram showing an example of a schematic configuration of a vehicle equipped with an agent device.

FIG. 7 is a flowchart showing a flow of a series of processing steps of an information providing device of the embodiment.

FIG. 8 is a diagram for describing a method of extracting a feature quantity.

FIG. 9 is a diagram showing an example of a feature quantity output according to an estimation model.

FIG. 10 is a diagram for describing a profile estimation method.

FIG. 11 is a diagram showing an example of corresponding relationships between a profile, an amount of data in a dictionary, and a frequency of a function.

FIG. 12 is a diagram schematically showing a scene in which setting guidance information is provided.

FIG. 13 is a flowchart showing a flow of a series of processing steps during training of an estimation model.

FIG. 14 is a diagram schematically showing a training method of an estimation model.

### DESCRIPTION OF EMBODIMENTS

Hereinafter, embodiments of an information processing device, an information processing method, and a storage medium of the present invention will be described with reference to the drawings.

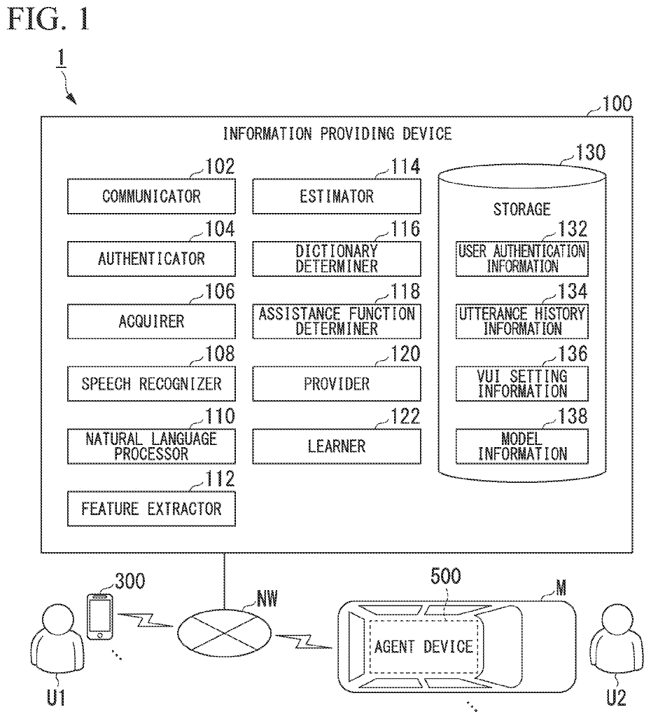

FIG. 1 is a configuration diagram of an information providing system 1 of the embodiment. The information providing system 1 includes, for example, an information providing device 100, a communication terminal 300 used by a user U1 of the information providing system 1, and a vehicle M used by a user U2 of the information providing system 1. These components can communicate with each other via a network NW. The network NW includes, for example, the Internet, a wide area network (WAN), a local area network (LAN), a telephone circuit, a public circuit, a dedicated circuit, a provider device, a radio base station, and the like. The information providing system 1 may include a plurality of communication terminals 300 and/or a plurality of vehicles M. The vehicle M includes, for example, an agent device 500. The information providing device 100 is an example of the “information processing device.”

The information providing device 100 receives an inquiry or a request of the user U1 or the like from the communication terminal 300, performs a process according to the received inquiry or request, and transmits a processing result to the communication terminal 300. Also, the information providing device 100 receives an inquiry or request of the user U2 or the like from the agent device 500 mounted in the vehicle M, performs a process according to the received inquiry or request, and transmits a processing result to the agent device 500. The information providing device 100 may function as, for example, a cloud server that communicates with the communication terminal 300 and the agent device 500 via the network NW and transmits and receives various types of data.

The communication terminal 300 is, for example, a portable terminal such as a smartphone or a tablet terminal. The communication terminal 300 receives information of an inquiry, a request, or the like from the user U1. The communication terminal 300 transmits the information received from the user U1 to the information providing device 100 and outputs information obtained as a response to the transmitted information. That is, the communication terminal 300 functions as a voice user interface.

The vehicle M in which the agent device 500 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power with which a secondary battery or a fuel cell is discharged. The vehicle M may be an automated driving vehicle. The automated driving is, for example, automatically controlling one or both of the steering or the speed of the vehicle to execute the driving control. The driving control of the vehicle described above may include, for example, various types of driving control such as adaptive cruise control (ACC), auto lane changing (ALC), and lane keeping assistance system (LKAS). In the automated driving vehicle, driving may be controlled according to the manual driving of an occupant (a driver).

The agent device 500 interacts with the occupant of the vehicle M (for example, the user U2) or provides information for an inquiry or a request from the occupant or the like. The agent device 500 receives, for example, information of an inquiry or a request from the user U2 or the like, transmits the received information to the information providing device 100, and outputs information obtained as a response to the transmitted information. That is, like the communication terminal 300, the agent device 500 functions as the voice user interface.

### Information Providing Device

Hereinafter, a configuration of the information providing device 100 will be described. The information providing device 100 includes, for example, a communicator 102, an authenticator 104, an acquirer 106, a speech recognizer 108, a natural language processor 110, a feature extractor 112, an estimator 114, a dictionary determiner 116, an assistance function determiner 118, a provider 120, a learner 122, and a storage 130. The feature extractor 112 is an example of an “extractor.” The dictionary determiner 116 is an example of a “first determiner.” The assistance function determiner 118 is an example of a “second determiner.”

Each of the authenticator 104, the acquirer 106, the speech recognizer 108, the natural language processor 110, the feature extractor 112, the estimator 114, the dictionary determiner 116, the assistance function determiner 118, the provider 120, and the learner 122 is implemented by, for example, a hardware processor such as a central processing unit (CPU) executing a program (software). Some or all of these components may be implemented by hardware (including a circuit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The program may be pre-stored in a storage device (a storage device including a non-transitory storage medium) such as a hard disk drive (HDD) or a flash memory or may be stored in a removable storage medium (a non-transitory storage medium) such as a DVD or a CD-ROM and installed in the storage device of the information providing device 100 when the storage medium is mounted in a drive device or the like.

The storage 130 is implemented by the above-mentioned various types of storage devices, an electrically erasable programmable read-only memory (EEPROM), a read-only memory (ROM), a random-access memory (RAM), or the like. In addition to the program referred to by the above-described processor, the storage 130 stores, for example, user authentication information 132, utterance history information 134, voice user interface (VUI) setting information 136, model information 138, and the like.

The user authentication information 132 includes, for example, information for identifying a user who uses the information providing device 100, information used at the time of authentication by the authenticator 104, and the like. The user authentication information 132 is, for example, a user ID, a password, an address, a name, an age, a gender, a hobby, a special skill, orientation information, and the like. The orientation information is information indicating the orientation of the user, and is, for example, information indicating the user's way of thinking, information indicating preferences and the like (preference information), information indicating what the user values, and the like.

The utterance history information 134 is history information of words (i.e., an utterance) spoken by the user to the communication terminal 300 or the agent device 500 that functions as a voice user interface. The utterance history information 134 includes an utterance history of each of the plurality of users.

The VUI setting information 136 is information about settings of the communication terminal 300 or the agent device 500 that functions as the voice user interface. The VUI setting information 136 includes setting information for a voice user interface of each of the plurality of users.

The model information 138 is information (a program or a data structure) that defines an estimation model MDL to be described below.

The communicator 102 is an interface that communicates with the communication terminal 300, the agent device 500, and other external devices via the network NW. For example, the communicator 102 includes a network interface card (NIC), an antenna for wireless communication, and the like.

The authenticator 104 registers information about users (for example, the users U1 and U2) who use the information providing system 1 as the user authentication information 132 in the storage 130. For example, when a user registration request has been received from the communication terminal 300 or the agent device 500, the authenticator 104 causes a device from which the registration request has been received to display a graphical user interface (GUI) for inputting various types of information included in the user authentication information 132. When the user inputs various types of information to the GUI, the authenticator 104 acquires information about the user from the device. The authenticator 104 registers the information about the user acquired from the communication terminal 300 or the agent device 500 as the user authentication information 132 in the storage 130.

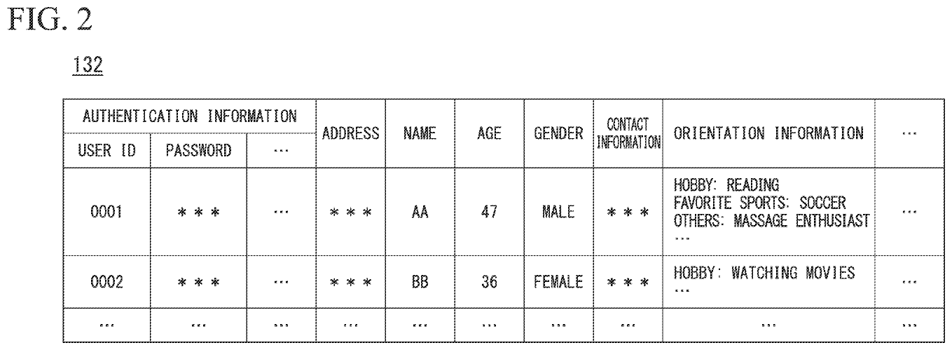

FIG. 2 is a diagram for describing content of the user authentication information 132. In the user authentication information 132, for example, information such as an address, a name, an age, a gender, contact information, and orientation information of the user is associated with the user's authentication information. The authentication information includes, for example, a user ID, a password, and the like, which are identification information for identifying the user. Also, the authentication information may include biometric information such as fingerprint information and iris information. The contact information may be, for example, address information for communicating with the voice user interface (the communication terminal 300 or the agent device 500) used by the user, or may be a telephone number, an e-mail address, terminal identification information, or the like of the user. The information providing device 100 communicates with various types of mobile communication devices on the basis of the contact information and provides various types of information.

The authenticator 104 authenticates a user of a service of the information providing system 1 on the basis of the user authentication information 132 registered in advance. For example, the authenticator 104 authenticates the user at a timing when a service use request has been received from the communication terminal 300 or the agent device 500. Specifically, when the use request has been received, the authenticator 104 causes a terminal device, which has transmitted the request, to display a GUI for inputting authentication information such as a user ID or a password and compares the input authentication information input to the GUI with authentication information of the user authentication information 132. The authenticator 104 determines whether or not the authentication information matching the input authentication information has been stored in the user authentication information 132 and allows the use of a service when the authentication information matching the input authentication information has been stored. On the other hand, when the authentication information matching the input authentication information has not been stored, the authenticator 104 performs a process of prohibiting the use of the service or causing new registration to be performed.

The acquirer 106 acquires utterances of one or more users from the communication terminal 300 or the agent device 500 via the communicator 102 (via the network NW) and causes the storage 130 to store the utterances as the utterance history information 134. The user's utterance may be speech data (also referred to as sound data or a sound stream) or may be text data recognized from the speech data.

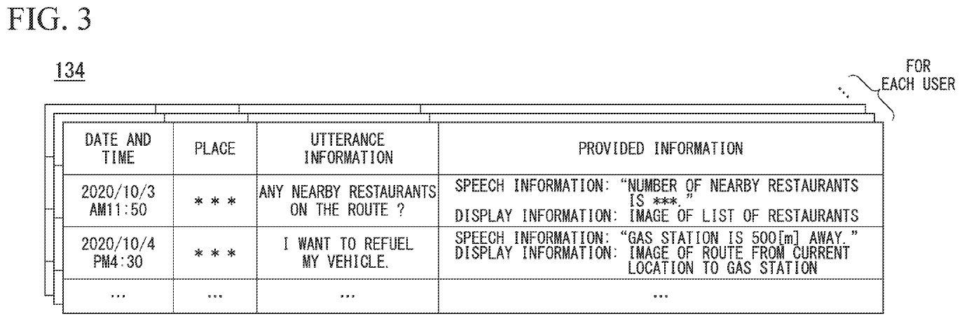

FIG. 3 is a diagram for describing content of the utterance history information 134. In the utterance history information 134, for example, a place where the utterance was made (location information), content of the utterance, and provided information are associated with a date and time when the user made the utterance. The utterance content may be speech uttered by the user or may be text obtained by speech recognition by the speech recognizer 108 described below. The provided information is information provided by the provider 120 as a response to the user's utterance. The provided information includes, for example, speech information for a dialogue and display information of an image, an operation, and the like.

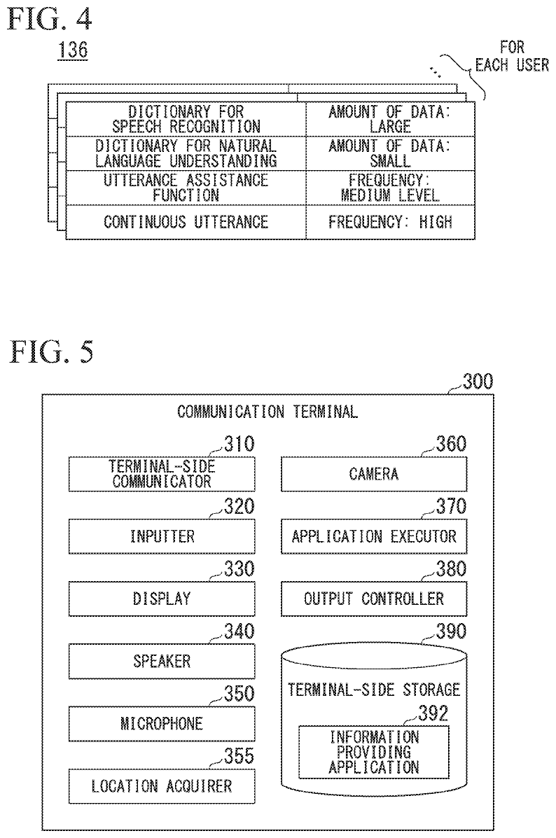

FIG. 4 is a diagram for describing content of the VUI setting information 136. The VUI setting information 136 is, for example, information set for each user in association with an amount of data in a dictionary for speech recognition, an amount of data in a dictionary for natural language understanding, an activation frequency of an utterance assistance function, an output frequency of speech output from the voice user interface according to the utterance assistance function, and the like. Details of the setting information will be described below.

The speech recognizer 108 performs speech recognition for recognizing the user's utterance speech (a process of textualizing speech). For example, the speech recognizer 108 performs speech recognition on speech data representing the user's utterance acquired by the acquirer 106 and generates text data obtained by textualizing the speech data. The text data includes a string in which content of the utterance is written as text.

For example, the speech recognizer 108 may textualize speech data using a sound model and a dictionary for automatic speech recognition (ASR) (hereinafter referred to as an ASR dictionary). The sound model is a model that is pre-learned or adjusted so that input speech is separated in accordance with a frequency and each element of the separated speech is converted into a phoneme (a spectrogram) and is, for example, a neural network, a hidden Markov model, or the like. The ASR dictionary is a database in which a string is associated with a combination of a plurality of phonemes and a position for separating the string is defined by a syntax. The ASR dictionary is a so-called pattern matching dictionary. For example, the speech recognizer 108 inputs speech data to a sound model, searches the ASR dictionary for a set of phonemes output by the sound model, and acquires a string corresponding to the set of phonemes. The speech recognizer 108 generates a combination of strings obtained as described above as text data. Also, instead of using the ASR dictionary, the speech recognizer 108 may generate text data from an output result of the sound model using, for example, a language model implemented by an n-gram model or the like. The ASR dictionary is an example of a “first dictionary.”

The natural language processor 110 performs natural language understanding to understand a structure or a meaning of text. For example, the natural language processor 110 interprets a meaning of the text data generated by the speech recognizer 108 with reference to a dictionary (hereinafter, a natural language understanding (NLU) dictionary) provided in advance for semantic interpretation. The NLU dictionary is a database in which abstract semantic information is associated with text data. For example, the NLU dictionary defines that a relevance level between the words “I” and “colleague” is high and a relevance level between the words “hamburger” and “eat” is high. Thereby, for example, the sentence “I ate a hamburger with a colleague” is not interpreted as having a meaning indicating that a single subject “I” performed the act of “eat” with respect to two objects such as “colleague” and “hamburger,” but is interpreted as having a meaning indicating that two subjects “I” and “colleague” performed the act “eat” with respect to a single object “hamburger.” The NLU dictionary may include a synonym, a quasi-synonym, and the like. Speech recognition and natural language understanding do not necessarily have to be separated as distinct stages and may affect each other in a process of receiving a result of natural language understanding and modifying a result of speech recognition or the like. The NLU dictionary is an example of a “second dictionary.”

The feature extractor 112 extracts a feature quantity based on a unique utterance from text data obtained from the speech data of the utterance in the speech recognition or text data whose syntax and meaning are understood in the natural language understanding. A unique utterance is, for example, an utterance having utterance content, an utterance speed, an utterance pattern, and the like different from those of the majority of other utterances in a population in which a plurality of utterances are collected. The population typically includes utterances of an unspecified number of users. For example, when the majority of users are saying “I want to eat sushi” and one user is saying “I especially want to eat sushi among Japanese foods,” the utterance of the user saying “I especially want to eat sushi among Japanese foods” becomes a unique utterance. In this way, a minority of utterances are treated as unique utterances among a plurality of utterances (in a population).

The estimator 114 estimates a profile of the user who uses the voice user interface (the communication terminal 300 or the agent device 500) on the basis of a feature quantity based on the unique utterance extracted by the feature extractor 112. For example, the estimator 114 estimates the user's proficiency level (hereinafter referred to as a VUI proficiency level) for the voice user interface as a profile on the basis of the feature quantity. The VUI proficiency level is an index that quantitatively indicates whether or not the user is accustomed to using the voice user interface.

Also, for example, the estimator 114 estimates the user's affinity for the voice user interface (hereinafter referred to as a VUI affinity) as a profile, or estimates the user's affinity for an utterance of the voice user interface (hereinafter referred to as a dialogue affinity) as the profile, on the basis of the feature quantity. The VUI affinity is an index that quantitatively indicates how accustomed the user is to the voice user interface. The dialogue affinity is an index that quantitatively indicates how accustomed the user is to the utterance of the voice user interface. The affinity may be read as an index (i.e., a satisfaction level) that quantitatively indicates how satisfied the user is inwardly when using the voice user interface. The VUI affinity is an example of an “affinity” and the dialogue affinity is an example of a “second affinity.”

The dictionary determiner 116 determines amounts of data of at least one or both of the ASR dictionary used for the speech recognition and the NLU dictionary used for the natural language understanding for each user on the basis of the profile of each user (the VUI proficiency level, the VUI affinity, and the dialogue affinity of each user) estimated by the estimator 114. That is, the dictionary determiner 116 customizes the amount of data in the ASR dictionary or the NLU dictionary for each user.

The assistance function determiner 118 determines a frequency at which the utterance assistance function is activated for each user on the basis of the profile of each user (the VUI proficiency level, the VUI affinity, and the dialogue affinity of each user) estimated by the estimator 114. The utterance assistance function is a function that assists the user's behavior using the utterance of the voice user interface. For example, the utterance assistance function includes a route navigation function using speech or the like in response to a request when the user has requested the voice user interface to provide route guidance. Also, utterance assistance functions may include a music playback function, a schedule management function, an e-mail operation function, a news reading function, a video playback function, a function of purchasing products in cooperation with a shopping site, a remote-control function of controlling devices present in the vehicle M, the home, or the like, and the like. Further, the assistance function determiner 118 determines a frequency at which the voice user interface is allowed to continuously output the utterance under the utterance assistance function. The frequency of utterance is a frequency that quantitatively indicates how continuously speech is output (how continuously the utterance is made) per unit time period. An activation frequency of the utterance assistance function is an example of an “assistance frequency,” and the frequency at which the voice user interface is allowed to continuously output the utterance is an example of an “utterance frequency.”

The provider 120 provides (transmits) various types of information to the communication terminal 300 or the agent device 500, which is the voice user interface, via the communicator 102. For example, when the acquirer 106 has acquired an inquiry or a request as an utterance from the communication terminal 300 or the agent device 500, the provider 120 generates information that becomes a response to the inquiry or the request. For example, when an utterance meaning “tell me the weather today” is acquired, the provider 120 may generate content corresponding to the words “today” and “weather” (an image, a video, or speech representing a result of a weather forecast or the like). The provider 120 returns the generated information to the voice user interface where the inquiry or the request has been made via the communicator 102.

Also, the provider 120 provides the communication terminal 300 or the agent device 500 with setting guidance information of various types of dictionaries whose amounts of data are determined by the dictionary determiner 116. The setting guidance information of the dictionary is, for example, information for recommending the user to newly refer to (use) the ASR dictionary whose amount of data is personalized at the time of speech recognition or information for recommending the user to perform a setting process so that an NLU dictionary whose amount of data is personalized is newly referred to (used) at the time of natural language understanding.

Also, the provider 120 may provide the communication terminal 300 or the agent device 500 with setting guidance information of the utterance assistance function whose frequency is determined by the assistance function determiner 118. The setting guidance information of the utterance assistance function is, for example, information for recommendation to a user so that the user sets a frequency at which the utterance assistance function is activated or a frequency at which an utterance continues according to the utterance assistance function to a frequency (i.e., a personalized frequency) determined by the assistance function determiner 118.

### Communication Terminal

Next, a configuration of the communication terminal 300 will be described. FIG. 5 is a configuration diagram of the communication terminal 300 of the embodiment. The communication terminal 300 includes, for example, a terminal-side communicator 310, an inputter 320, a display 330, a speaker 340, a microphone 350, a location acquirer 355, a camera 360, an application executor 370, an output controller 380, and a terminal-side storage 390. The location acquirer 355, the application executor 370, and the output controller 380 are implemented by, for example, a hardware processor such as a CPU executing a program (software). Also, some or all of these components may be implemented by hardware (including a circuit; circuitry) such as an LSI circuit, an ASIC, an FPGA, or a GPU or may be implemented by software and hardware in cooperation. The program may be pre-stored in a storage device (a storage device including a non-transitory storage medium) such as an HDD or a flash memory or may be stored in a removable storage medium (a non-transitory storage medium) such as a DVD or a CD-ROM or may be installed in the storage device of the communication terminal 300 when the storage medium is mounted in a drive device, a card slot, or the like.

The terminal-side storage 390 may be implemented by the above-mentioned various types of storage devices, EEPROM, ROM, RAM, or the like. The terminal-side storage 390 stores, for example, the above-mentioned program, the information providing application 392, and various other types of information.

The terminal-side communicator 310 uses, for example, the network NW to communicate with the information providing device 100, the agent device 500, and other external devices.

The inputter 320 receives the input of the user U1 by operating, for example, various types of keys or buttons or the like. The display 330 is, for example, a liquid crystal display (LCD), an organic electro-luminescence (EL) display, or the like. The inputter 320 may be configured to be integrated with the display 330 as a touch panel. The display 330 displays various types of information in the embodiment according to the control of the output controller 380. For example, the speaker 340 outputs prescribed speech according to the control of the output controller 380. For example, the microphone 350 receives an input of speech of the user U1 according to the control of the output controller 380.

The location acquirer 355 acquires location information of the communication terminal 300. For example, the location acquirer 355 includes a global navigation satellite system (GNSS) receiver represented by a global positioning system (GPS) or the like. The location information may be, for example, two-dimensional map coordinates or latitude/longitude information. The location acquirer 355 may transmit the acquired location information to the information providing device 100 via the terminal-side communicator 310.

The camera 360 is, for example, a digital camera that uses a solid-state image sensor (an image sensor) such as a charge coupled device (CCD) or a complementary metal oxide semiconductor (CMOS). For example, when the communication terminal 300 is attached to an instrument panel of the vehicle M as a substitute for a navigation device or the like, the camera 360 of the communication terminal 300 may image a cabin of the vehicle M automatically or in accordance with the operation of the user U1.

The application executor 370 executes the information providing application 392 stored in the terminal-side storage 390. The information providing application 392 is an application program for controlling the output controller 380 so that an image provided by the information providing device 100 is output to the display 330 and speech corresponding to the information provided by the information providing device 100 is output from the speaker 340. Also, the application executor 370 transmits the information input by the inputter 320 to the information providing device 100 via the terminal-side communicator 310. For example, the information providing application 392 may be downloaded from an external device via the network NW and installed in the communication terminal 300.

The output controller 380 causes the display 330 to display an image or causes the speaker 340 to output speech according to the control of the application executor 370. At that time, the output controller 380 may control content or a mode of the image to be displayed on the display 330 or may control content or a mode of the speech to be output to the speaker 340.

### Vehicle

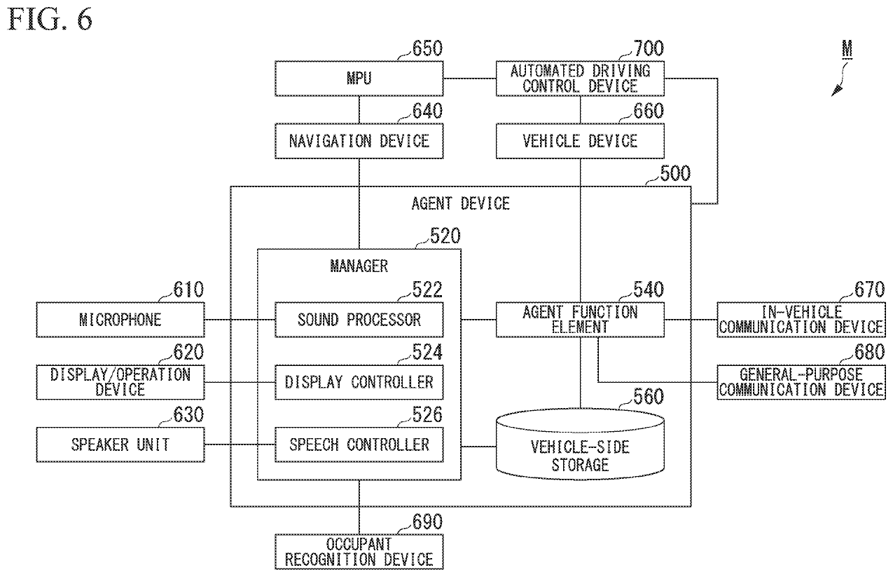

Next, a schematic configuration of the vehicle M in which the agent device 500 is mounted will be described. FIG. 6 is a diagram showing an example of a schematic configuration of the vehicle M in which the agent device 500 is mounted. The vehicle M shown in FIG. 6 includes the agent device 500, a microphone 610, a display/operation device 620, a speaker unit 630, a navigation device 640, a map positioning unit (MPU) 650, a vehicle device 660, an in-vehicle communication device 670, an occupant recognition device 690, and an automated driving control device 700. A general-purpose communication device 680 such as a smartphone may be brought into a cabin and used as a communication device. The general-purpose communication device 680 is, for example, the communication terminal 300. These devices are connected to each other through a multiplex communication line such as a controller area network (CAN) communication line, a serial communication line, a wireless communication network, or the like.

First, a configuration other than the agent device 500 will be described. The microphone 610 is a sound collector that collects speech uttered within the cabin. The display/operation device 620 is a device (or a device group) capable of displaying an image and receiving an input operation. The display/operation device 620 is typically a touch panel. The display/operation device 620 may further include a head-up display (HUD) or a mechanical input device. The speaker unit 630 outputs, for example, speech, an alarm sound, or the like inside or outside of the vehicle. The display/operation device 620 may be shared by the agent device 500 and the navigation device 640.

The navigation device 640 includes a navigation human-machine interface (HMI), a positioning device such as a GPS, a storage device that stores map information, and a control device (a navigation controller) that performs a route search and the like. Some or all of the microphone 610, the display/operation device 620, and the speaker unit 630 may be used as the navigation HMI. The navigation device 640 searches for a route (a navigation route) for moving from the location of the vehicle M to a destination input by the user from the map information with reference to the map information on the basis of the location of the vehicle M identified by the positioning device and outputs guidance information using the navigation HMI so that the vehicle M can travel along the route. The route search function may be provided in the information providing device 100 or the navigation server that can be accessed via the network NW. In this case, the navigation device 640 acquires a route from the information providing device 100 or the navigation server and outputs guidance information. Also, the agent device 500 may be constructed on the basis of the navigation controller. In this case, the navigation controller and the agent device 500 are configured to be integrated on the hardware.

For example, the MPU 650 divides a route on the map provided from the navigation device 640 into a plurality of blocks (for example, divides the route every 100 [m] in a traveling direction of the vehicle) and determines a recommended lane for each block. For example, the MPU 650 determines what number lane the vehicle travels in from the left. Also, the MPU 650 may determine the recommended lane using map information (a higher-precision map) that is more precise than the map information stored in the storage device of the navigation device 640. The higher-precision map may be stored in, for example, the storage device of the MPU 650, or may be stored in the storage device of the navigation device 640 or the vehicle-side storage 560 of the agent device 500. The higher-precision map may include information about the center of the lane or information about the boundary of the lane, traffic regulation information, address information (address/postal code), facility information, telephone number information, and the like.

The vehicle device 660 is, for example, a camera, a radar device, a light detection and ranging (LIDAR) sensor, or a physical object recognition device. The camera is, for example, a digital camera using a solid-state imaging element such as a CCD or a CMOS. The camera is attached to any location on the vehicle M. The radar device radiates radio waves such as millimeter waves around the vehicle M and detects radio waves (reflected waves) reflected by a physical object to detect at least a location (a distance and a direction) of the physical object. The LIDAR sensor radiates light around the vehicle M and measures scattered light. The LIDAR sensor detects a distance to a target on the basis of a time period from light emission to light reception. The physical object recognition device performs sensor fusion processing on detection results of some or all of the camera, the radar device, and the LIDAR sensor, and recognizes a location, a type, a speed, and the like of a physical object near the vehicle M. The physical object recognition device outputs a recognition result to the agent device 500 and the automated driving control device 700.

The vehicle device 660 includes, for example, driving operators, a travel driving force output device, a brake device, a steering device, and the like. The driving operators include, for example, an accelerator pedal, a brake pedal, shift levers, a steering wheel, a variant steering wheel, a joystick, and other operators. A sensor for detecting the amount of operation or the presence or absence of operation is attached to the driving operator and a detection result is output to the agent device 500, the automated driving control device 700, or some or all of the travel driving force output device, the brake device, and the steering device. The travel driving force output device outputs a travel driving force (torque) for the vehicle M to travel to the drive wheels. The brake device includes, for example, a brake caliper, a cylinder that transfers hydraulic pressure to the brake caliper, an electric motor that generates hydraulic pressure in the cylinder, and a brake ECU. The brake ECU controls the electric motor in accordance with information input from the automated driving control device 700 or information input from the driving operator so that the brake torque according to the braking operation is output to each wheel. The steering device includes, for example, a steering ECU and an electric motor. For example, the electric motor changes a direction of steerable wheels by applying a force to a rack and pinion mechanism. The steering ECU drives the electric motor in accordance with the information input from the automated driving control device 700 or the information input from the driving operator to change the direction of the steerable wheels.

Also, the vehicle device 660 may include, for example, vehicle devices such as a door lock device, a door opening/closing device, a window, a window opening/closing device, a window opening/closing controller, a seat, a seat position controller, a rearview mirror, a rearview-mirror angle position controller, lighting devices inside and outside of the vehicle, a lighting device controller, a wiper, a defogger, a wiper or defogger controller, a direction indicator, a direction indicator controller, an air conditioner, and the like.

The in-vehicle communication device 670 is, for example, a wireless communication device that can access the network NW using a cellular network or a Wi-Fi network.

The occupant recognition device 690 includes, for example, a sitting sensor, a cabin camera, an image recognition device, and the like. The sitting sensor includes a pressure sensor provided on a lower part of a seat, a tension sensor attached to a seat belt, and the like. The cabin camera is a CCD camera or a CMOS camera installed in the cabin. The image recognition device analyzes an image of the cabin camera, recognizes the presence/absence of a user for each seat, a face of the user, and the like, and recognizes a sitting location of the user. Also, the occupant recognition device 690 may identify the user sitting in the driver's seat or a passenger seat or the like included in the image by performing a matching process associated with a facial image registered in advance.

The automated driving control device 700 performs a process, for example, when a hardware processor such as a CPU executes a program (software). Some or all of the components of the automated driving control device 700 may be implemented by hardware (including a circuit; circuitry) such as an LSI circuit, an ASIC, an FPGA, or a GPU or may be implemented by software and hardware in cooperation. The program may be pre-stored in a storage device (a storage device including a non-transitory storage medium) such as an HDD or a flash memory of the automated driving control device 700 or may be stored in a removable storage medium such as a DVD or a CD-ROM and installed in the HDD or the flash memory of the automated driving control device 700 when the storage medium (the non-transitory storage medium) is mounted in a drive device.

The automated driving control device 700 recognizes states of a location, a speed, acceleration, and the like of a physical object near the vehicle M on the basis of the information input via the physical object recognition device of the vehicle device 660. The automated driving control device 700 generates a future target trajectory along which the vehicle M automatically travels (independently of the driver's operation) so that the vehicle M can generally travel in the recommended lane determined by the MPU 650 and cope with a surrounding situation of the vehicle M. For example, the target trajectory includes a speed element. For example, the target trajectory is represented by sequentially arranging points (trajectory points) at which the vehicle M is required to arrive.

The automated driving control device 700 may set an automated driving event when a target trajectory is generated. Automated driving events include a constant-speed driving event, a low-speed tracking driving event, a lane change event, a branch-point-related event, a merge-point-related event, a takeover event, an automated parking event, and the like. The automated driving control device 700 generates a target trajectory according to an activated event. Also, the automated driving control device 700 controls the travel driving force output device, the brake device, and the steering device of the vehicle device 660 so that the vehicle M passes the generated target trajectory on time. For example, the automated driving control device 700 controls the travel driving force output device or the brake device on the basis of a speed element associated with a target trajectory (a trajectory point) or controls the steering device in accordance with a degree of curvature of the target trajectory.

Next, the agent device 500 will be described. The agent device 500 is a device that interacts with the occupant of the vehicle M. For example, the agent device 500 transmits an utterance of the occupant to the information providing device 100 and receives a response to the utterance from the information providing device 100. The agent device 500 presents the received response to the occupant using speech or an image.

The agent device 500 includes, for example, a manager 520, an agent function element 540, and a vehicle-side storage 560. The manager 520 includes, for example, a sound processor 522, a display controller 524, and a speech controller 526. In FIG. 6, the arrangement of these components is simply shown for the sake of description and, for example, the manager 520 may be actually interposed between the agent function element 540 and the vehicle-mounted communication device 60. The arrangement can be modified arbitrarily.

Each component other than the vehicle-side storage 560 of the agent device 500 is implemented by, for example, a hardware processor such as a CPU executing a program (software). Some or all of these components may be implemented by hardware (including a circuit; circuitry) such as an LSI circuit, an ASIC, an FPGA, or a GPU or may be implemented by software and hardware in cooperation. The program may be pre-stored in a storage device (a storage device including a non-transitory storage medium) such as an HDD or a flash memory or may be stored in a removable storage medium (the non-transitory storage medium) such as a DVD or a CD-ROM and installed when the storage medium is mounted in a drive device.

The vehicle-side storage 560 may be implemented by the above-mentioned various types of storage devices, EEPROM, ROM, RAM, or the like. The vehicle-side storage 560 stores, for example, programs and various other types of information.

The manager 520 functions by executing a program such as an operating system (OS) or middleware.

The sound processor 522 performs sound processing on an input sound so that the input sound is in a state suitable for recognizing information related to an inquiry, a request, or the like within various types of speech received from the occupant (for example, the user U2) of the vehicle M. Specifically, the sound processor 522 may perform sound processing such as noise removal.

The display controller 524 generates an image related to a response result for an inquiry or a request from the occupant of the vehicle M for an output device such as the display/operation device 620 in accordance with an instruction from the agent function element 540. The image related to the response result is, for example, an image showing a list of stores and facilities showing the response result for an inquiry, a request, or the like, an image related to each store or facility, an image showing a traveling route to a destination, other recommendation information, an image showing the start or end of a process, or the like. Also, the display controller 524 may generate an anthropomorphic character image (hereinafter referred to as an agent image) that communicates with the occupant in accordance with an instruction from the agent function element 540. The agent image is, for example, an image of a mode of talking to an occupant. The agent image may include, for example, a facial image, so that a facial expression or a facial orientation are recognized by at least a viewer (the occupant). The display controller 524 causes the display/operation device 620 to output the generated image.

The speech controller 526 causes some or all of the speakers included in the speaker unit 630 to output speech in accordance with an instruction from the agent function element 540. The speech includes, for example, speech for the agent image to have a dialogue with the occupant or speech corresponding to the image output to the display/operation device 620 by the display controller 524. Also, the speech controller 526 may perform control for localizing a sound image of agent speech at a position corresponding to a display position of the agent image using a plurality of speakers included in the speaker unit 630. The position corresponding to the display position of the agent image is, for example, a position where the occupant is expected to feel that the agent image is speaking the agent speech, and is, specifically, a position near the display position of the agent image (for example, within 2˜3 [cm]). Also, the localization of the sound image is, for example, a process of determining a spatial position of a sound source felt by the occupant by adjusting a volume of a sound that is transferred to the left and right ears of the user.

The agent function element 540 causes an agent image or the like to appear in cooperation with the information providing device 100 on the basis of various types of information acquired by the manager 520 and provides a service including a speech response in accordance with an utterance of the occupant of the vehicle M. For example, the agent function element 540 activates the agent on the basis of an activation word included in the speech processed by the sound processor 522 or ends the agent on the basis of an end word. Also, the agent function element 540 transmits speech data processed by the sound processor 522 to the information providing device 100 via the in-vehicle communication device 670 or provides information obtained from the information providing device 100 to the occupant. Also, the agent function element 540 may have a function of cooperating with the general-purpose communication device 680 and communicating with the information providing device 100. In this case, the agent function element 540 is paired with the general-purpose communication device 680 using, for example, Bluetooth (registered trademark) and the agent function element 540 is connected to the general-purpose communication device 680. Also, the agent function element 540 may be configured to be connected to the general-purpose communication device 680 according to wired communication using a universal serial bus (USB) or the like.

### Processing Flow of Information Providing Device

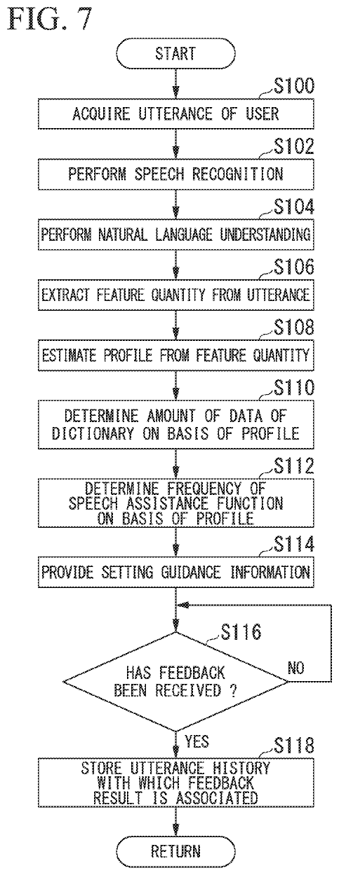

Next, the flow of a series of processing steps of the information providing device 100 will be described using a flowchart. FIG. 7 is a flowchart showing a flow of a series of processing steps of the information providing device 100 of the embodiment.

First, the acquirer 106 acquires an utterance of a certain user (hereinafter referred to as a target user) from the communication terminal 300 or the agent device 500 (i.e., the voice user interface) via the communicator 102 for a prescribed period (step S100). The acquirer 106 causes the storage 130 to store the acquired utterance of the target user as the utterance history information 134.

Subsequently, the speech recognizer 108 performs speech recognition for the utterance of the target user and generates text data from the utterance of the target user (step S102). When the utterance is already textualized in the communication terminal 300 or the agent device 500, i.e., when the utterance of the target user acquired by the acquirer 106 is text data, the processing of S102 may be omitted.

Subsequently, the natural language processor 110 performs natural language understanding on the text data obtained from the utterance of the target user, and understands the meaning of the text data (step S104). At this time, the natural language processor 110 vectorizes the text data (the textualized utterance) using term frequency (TF)-inverse document frequency (IDF), Word2Vec, and the like.

Subsequently, the feature extractor 112 extracts a feature quantity based on the unique utterance from the vectorized text data (step S106).

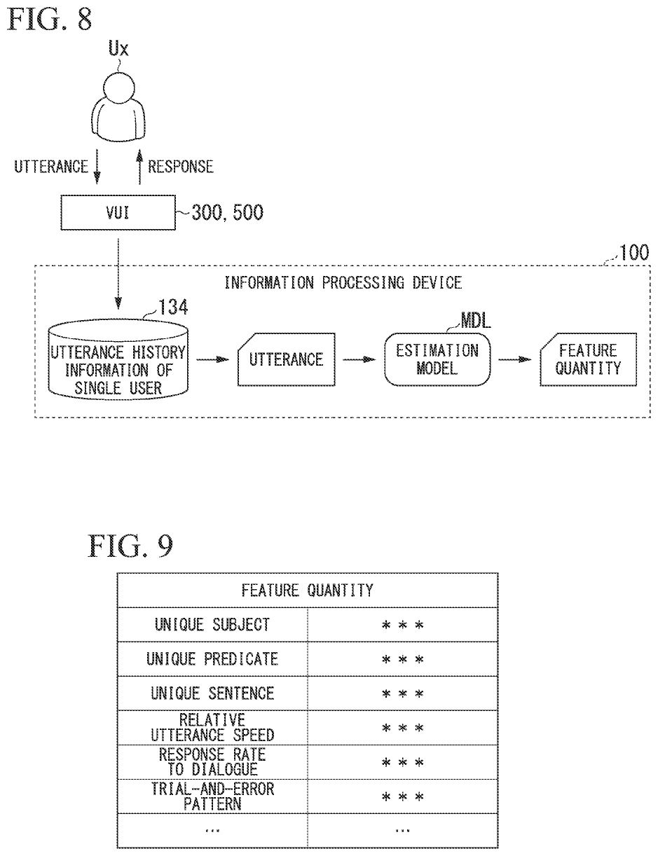

FIG. 8 is a diagram for describing a method of extracting a feature quantity. For example, it is assumed that a user Ux has a dialogue with the voice user interface of either the communication terminal 300 or the agent device 500. In this case, speech spoken by the user Ux in the dialogue is stored in the storage 130 as the utterance history information 134 of a single user called the user Ux. The feature extractor 112 extracts a feature quantity of a unique utterance by acquiring the text data derived from the utterance of the user Ux included in the utterance history information 134 and inputting the acquired text data into the estimation model MDL defined by the model information 138.

The estimation model MDL is, for example, a machine learning model trained or learned to output a feature quantity of a unique utterance when text data of an utterance is input. Also, the estimation model MDL is not limited to the machine learning model and may be a statistical model. The output of the estimation model MDL may be, for example, a multidimensional vector or tensor having the presence or absence of a feature quantity, a degree of the feature quantity, and the like as elements. Such an estimation model MDL may be implemented by various models such as a neural network, a support vector machine, a mixed Gaussian model, and a naive Bayes classifier. Hereinafter, as an example, the estimation model MDL will be described as being implemented by a neural network.

When the estimation model MDL is implemented by the neural network, the model information 138 includes, for example, various types of information such as coupling information about how units included in each of a plurality of layers constituting the neural network are coupled to each other and a coupling coefficient given to data input/output between coupled units.

The coupling information includes, for example, information such as the number of units included in each layer, information for designating a type of unit to which each unit is coupled, an activation function for implementing each unit, a gate provided between the units in a hidden layer, and the like. The activation function of implementing the unit may be, for example, a normalized linear function (a ReLU function), a sigmoid function, a step function, another function, or the like. The gate selectively passes or weights data transferred between the units, for example, in accordance with a value (for example, 1 or 0) returned by the activation function. The coupling coefficient includes, for example, a weight value given to output data when data is output from a unit of a certain layer to a unit of a deeper layer in the hidden layer of the neural network. Also, the coupling coefficient may include a bias component unique to each layer and the like.

FIG. 9 is a diagram showing an example of a feature quantity output by the estimation model MDL. As shown in FIG. 9, in a feature quantity of a unique utterance, for example, a unique subject, a unique predicate, a unique sentence, a relative utterance speed, a response rate to a dialogue, a trial-and-error pattern, and the like are included.

The unique subject is a subject whose appearance frequency is less than a threshold value in a population including a plurality of utterances. The unique predicate is a predicate whose appearance frequency is less than the threshold value in the population including the plurality of utterances. Each of the subject and predicate mentioned here may be one word or one phrase in which a plurality of words are combined. The unique sentence is a sentence whose appearance frequency is less than the threshold value in the population including the plurality of utterances.

The relative utterance speed is a speed of a unique utterance relative to a normal utterance speed. A normal utterance is an utterance in which the appearance frequency of the subject, the predicate, or the like is equal to or higher than the threshold value (i.e., a non-unique utterance) in the population. The response rate to the dialogue is an index indicating a rate at which the user responds to the utterance of the voice user interface.

The trial-and-error pattern is a user's utterance pattern when an error that makes it impossible to interact with the voice user interface occurs. The error mentioned here means, for example, a case where a meaning intended by the user due to an utterance of a word unregistered in the ASR dictionary used for the speech recognition or the NLU dictionary used for the natural language understanding may not be interpreted or a case where no utterance may be returned from the voice user interface even though the user has made an utterance because a response corresponding to the user's utterance is not prepared. For example, the trial-and-error pattern includes a first pattern in which the user speaks to the voice user interface when an error has occurred, a second pattern in which the user has made no utterance to the voice user interface when an error has occurred, a third pattern in which an error itself has not occurred, and the like.

Description returns to the flowchart of FIG. 7. Subsequently, the estimator 114 estimates a profile of the target user who uses the voice user interface on the basis of the feature quantity of the target user extracted by the feature extractor 112 (step S108).

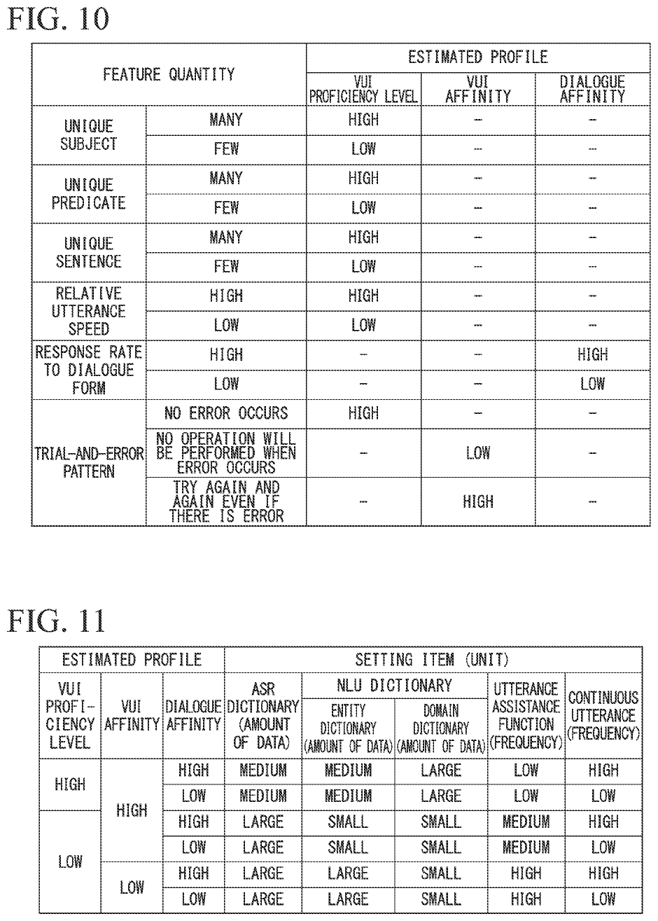

FIG. 10 is a diagram for describing a profile estimation method. For example, the estimator 114 estimates that the target user has a high VUI proficiency level when the feature quantity of the unique subject (the number of subjects) is greater than or equal to the threshold value, i.e., when there are many unique subjects in the utterance of the target user. On the other hand, the estimator 114 estimates that the target user has a low VUI proficiency level when the feature quantity of the unique subject (the number of subjects) is less than the threshold value, i.e., when there are few unique subjects in the utterance of the target user.

Also, the estimator 114 estimates that the target user has a high VUI proficiency level when the feature quantity of the unique predicate (the number of predicates) is greater than or equal to a threshold value, i.e., when there are many unique predicates in the utterance of the target user. On the other hand, the estimator 114 estimates that the target user has a low VUI proficiency level when the feature quantity of the unique predicate (the number of predicates) is less than the threshold value, i.e., when there are few unique predicates in the utterance of the target user.

Also, the estimator 114 estimates that the target user has a high VUI proficiency level when the feature quantity of the unique sentence (the number of sentences) is greater than or equal to a threshold value, i.e., when there are many unique sentences in the utterance of the target user. On the other hand, the estimator 114 estimates that the target user has a low VUI proficiency level when the feature quantity of the unique sentence (the number of sentences) is less than the threshold value, i.e., when there are few unique sentences in the utterance of the target user.

Also, the estimator 114 estimates that the target user has a high VUI proficiency level when the relative utterance speed is greater than or equal to a threshold value, i.e., when the speed of the utterance of the target user relative to the normal utterance is high. On the other hand, the estimator 114 estimates that the target user has a low VUI proficiency level when the relative utterance speed is less than the threshold value, i.e., when the speed of the utterance of the target user relative to the normal utterance is low.

Also, the estimator 114 estimates that the dialogue affinity of the target user is high when the response rate to the dialogue is greater than or equal to a threshold value, i.e., when the response rate is high. On the other hand, the estimator 114 estimates that the dialogue affinity of the target user is low when the response rate to the dialogue is less than the threshold value, i.e., when the response rate is low.

Also, the estimator 114 estimates that the target user has a high VUI proficiency level when the trial-and-error pattern is the third pattern, i.e., when the error itself has not occurred. Also, the estimator 114 estimates that the VUI affinity of the target user is low if the trial-and-error pattern is the second pattern, i.e., if the user has made no utterance to the voice user interface when an error has occurred. Also, the estimator 114 estimates that the target user has a high VUI affinity if the trial-and-error pattern is the first pattern, i.e., if the user has made some utterance to the voice user interface when an error has occurred.

Also, relationships between various types of feature quantities and a profile described above are only an example and may be changed arbitrarily.

Description returns to the flowchart in FIG. 7. Subsequently, the dictionary determiner 116 determines amounts of data of at least one or both of the ASR dictionary used for the speech recognition and the NLU dictionary used for the natural language understanding on the basis of the profile of the target user (a VUI proficiency level, a VUI affinity, and a dialogue affinity of the target user) estimated by the estimator 114 (step S110).

Subsequently, the assistance function determiner 118 determines an activation frequency of the utterance assistance function and a continuous utterance frequency under the speech assistance function on the basis of the profile of the target user (the VUI proficiency level, the VUI affinity, and the dialogue affinity of the target user) estimated by the estimator 114 (step S112).

FIG. 11 is a diagram showing an example of corresponding relationships between a profile, an amount of data in a dictionary, and a frequency of a function. As shown in FIG. 11, the NLU dictionary includes an entity dictionary in which a plurality of entities are mutually associated and a domain dictionary in which a plurality of domains which are entity classification destinations are mutually associated. For example, it is assumed that there are a sushi restaurant called “AAA” and a hamburger restaurant called “BBB.” In this case, each store name such as “AAA” or “BBB” becomes an entity and the name “restaurant” that conceptually summarizes them becomes a domain. That is, the entity dictionary is a dictionary that defines relationships between two or more entities for each domain and the domain dictionary is a dictionary that defines relationships between two or more domains that are higher-level concepts of the entities.

The dictionary determiner 116 determines amounts of data of the ASR dictionary and the domain dictionary included in the NLU dictionary in accordance with the VUI proficiency level of the target user and determines an amount of data in the entity dictionary included in the NLU dictionary in accordance with the VUI proficiency level and the VUI affinity of the target user.

For example, the dictionary determiner 116 decreases an amount of data in the ASR dictionary when the VUI proficiency level of the target user is greater than or equal to the first threshold value Th1 (when the VUI proficiency level is high) as compared with when the VUI proficiency level is less than the first threshold value Th1 (when the VUI proficiency level is low).

Specifically, the dictionary determiner 116 makes an amount of data at a medium level in the ASR dictionary when the VUI proficiency level of the target user is greater than or equal to the first threshold value Th1 (when the VUI proficiency level is high) and increases an amount of data in the ASR dictionary when the VUI proficiency level of the target user is less than the first threshold value Th1 (when the VUI proficiency level is low).

Also, the dictionary determiner 116 increases an amount of data in the domain dictionary included in the NLU dictionary when the VUI proficiency level of the target user is greater than or equal to the first threshold value Th1 (when the VUI proficiency level is high) as compared with when the VUI proficiency level is less than the first threshold value Th1 (when the VUI proficiency level is low).

Specifically, the dictionary determiner 116 increases the amount of data in the domain dictionary when the VUI proficiency level of the target user is greater than or equal to the first threshold value Th1 (when the VUI proficiency level is high) and decreases the amount of data in the domain dictionary when the VUI proficiency level of the target user is less than the first threshold value Th1 (when the VUI proficiency level is low).

Also, the dictionary determiner 116 increases the amount of data in the entity dictionary included in the NLU dictionary when the VUI proficiency level of the target user is greater than or equal to a first threshold value Th1 and the VUI affinity of the target user is greater than or equal to a second threshold value Th2 (hereinafter referred to as case A2) as compared with when the VUI proficiency level of the target user is less than the first threshold value Th1 and the VUI affinity of the target user is greater than or equal to the second threshold value Th2 (hereinafter referred to as case A1). The first threshold value Th1 may be the same as or different from the second threshold value Th2.

Also, the dictionary determiner 116 increases the amount of data in the entity dictionary when the VUI proficiency level of the target user is less than the first threshold value Th1 and the VUI affinity of the target user is less than the second threshold value Th2 (hereinafter referred to as case A3) as compared with case A2.

Specifically, the dictionary determiner 116 minimizes the amount of data in the entity dictionary in case A1, makes an amount of data at a medium level in the entity dictionary in case A2, and maximizes the amount of data in the entity dictionary in case A3.

The assistance function determiner 118 determines the activation frequency of the utterance assistance function in accordance with the VUI proficiency level and the VUI affinity of the target user and determines the continuous utterance frequency in accordance with the dialogue affinity of the target user.

For example, the assistance function determiner 118 increases the activation frequency of the utterance assistance function when the VUI proficiency level of the target user is less than the first threshold value Th1 and the VUI affinity of the target user is greater than or equal to the second threshold value Th2 (hereinafter referred to as case B2) as compared with when the VUI proficiency level of the target user is greater than or equal to the first threshold value Th1 and the VUI affinity of the target user is greater than or equal to the second threshold value Th2 (hereinafter referred to as case B1).

Further, the assistance function determiner 118 increases the activation frequency of the utterance assistance function when the VUI proficiency level of the target user is less than the first threshold value Th1 and the VUI affinity of the target user is less than the second threshold value Th2 (hereinafter referred to as case B3) as compared with case B2.

Specifically, the assistance function determiner 118 minimizes the activation frequency of the utterance assistance function in case B1, makes an activation frequency of the utterance assistance function at a medium level in case B2, and maximizes the activation frequency of the utterance assistance function in case B3.

Also, the assistance function determiner 118 increases the continuous utterance frequency when the dialogue affinity of the target user is greater than or equal to a third threshold value Th3 (when the dialogue affinity is high) as compared with when the dialogue affinity of the target user is less than the third threshold value Th3 (when the dialogue affinity is low). The third threshold value Th3 may be the same as or different from the first threshold value Th1 and/or the second threshold value Th2.

Description returns to the flowchart in FIG. 7. Subsequently, the provider 120 associates the amount of data determined by the dictionary determiner 116 or the frequency determined by the assistance function determiner 118 with the user ID of the target user, causes the storage 130 to store an association result as the VUI setting information 136, and further provides (transmits) the setting guidance information of the VUI setting information 136 to the voice user interface used by the target user via the communicator 102 (step S114).

Next, the acquirer 106 determines whether or not feedback for the setting guidance information has been received from the voice user interface by the communicator 102 (S116).

When the feedback has been received by the communicator 102, the acquirer 106 associates a feedback result with the utterance history information 134 of the target user and causes the storage 130 to store an association result (step S118). Thereby, a process of the present flowchart ends.

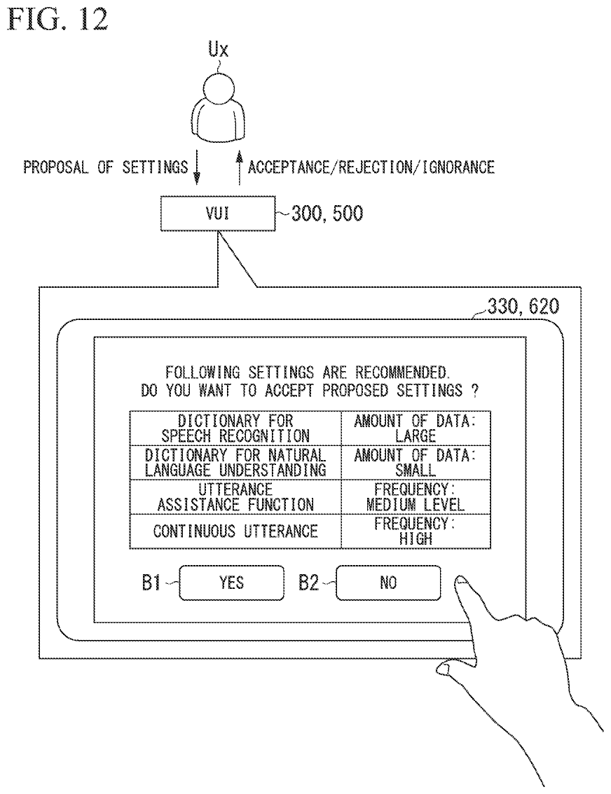

FIG. 12 is a diagram schematically showing a scene in which setting guidance information is provided. When the setting guidance information is received from the information providing device 100, the communication terminal 300, which is one of the voice user interfaces, causes the display 330 to display a GUI (not shown) in accordance with the setting guidance information. Likewise, when the setting guidance information is received from the information providing device 100, the agent device 500, which is one of the voice user interfaces, causes the display/operation device 620 to display a GUI (not shown) in accordance with the setting guidance information. For example, in the GUI, the amount of data in each dictionary included in the VUI setting information 136 or the frequency related to the utterance assistance function is displayed by a concrete numerical value or a qualitative expression. Also, the GUI may display a button B1 for accepting an amount of data or a frequency that has been proposed, a button B2 for rejecting the amount of data or the frequency that has been proposed, and the like. For example, when the target user Ux has touched the button B1, the communication terminal 300 or the agent device 500 may determine that the target user Ux has “accepted” the proposal. Also, the communication terminal 300 or the agent device 500 may determine that the target user Ux has “rejected” the proposal when the target user Ux has touched the button B2 and determine that the target user Ux has “ignored” the proposal when the target user Ux has touched no button during a period until a given time period elapses after the GUI is displayed. The communication terminal 300 or the agent device 500 feeds back these determination results to the information providing device 100.

For example, the information providing device 100 that has received the positive feedback of “acceptance” changes the amount of data in each dictionary of the target user or the frequency related to the utterance assistance function to the proposed one. Specifically, the speech recognizer 108 may perform the next and subsequent speech recognition of the target user who has returned the positive feedback of “acceptance” using the ASR dictionary whose amount of data has been determined by the dictionary determiner 116. The natural language processor 110 may perform the next and subsequent natural language understanding of the target user who has returned the positive feedback of “acceptance” using the NLU dictionary whose amount of data has been determined by the dictionary determiner 116. The provider 120 may perform the next and subsequent utterance assistance for the target user who has returned the positive feedback of “acceptance” at a frequency determined by the assistance function determiner 118.

Also, the information providing device 100 may automatically change the amount of data in each dictionary of the target user or the frequency of the utterance assistance function to the proposed one without receiving the feedback of the target user.

### Training Flow of Estimated Model

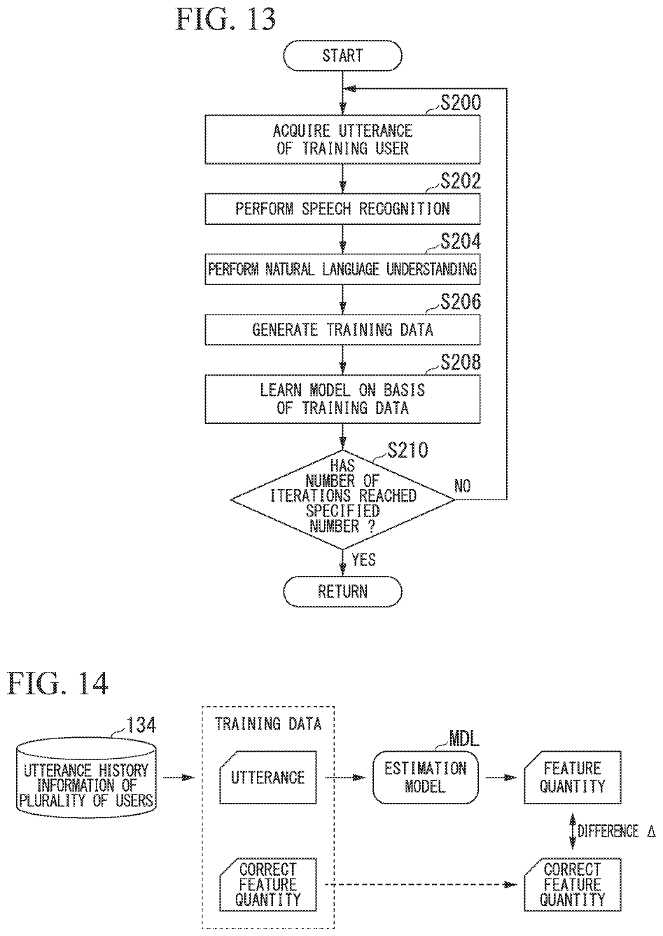

Hereinafter, a process at the time of training of the estimation model MDL will be described using a flowchart. FIG. 13 is a flowchart showing a flow of a series of processing steps at the time of training of the estimation model MDL.

First, the learner 122 acquires an utterance of one user serving as a training target (hereinafter referred to as a training user) from the utterance history information 134 including the utterances of an unspecified number of users (step S200). In the utterance history information 134, it is assumed that a user ID of each user is associated with the above-described feedback result.

Subsequently, the speech recognizer 108 performs speech recognition on the utterance of the training user and generates text data from the utterance of the training user (step S202). When text data for the utterance of the training user is already present, the processing of S202 may be omitted.

Subsequently, the natural language processor 110 performs natural language understanding on the text data obtained from the utterance of the training user and understands the meaning of the text data (step S204). At this time, the natural language processor 110 vectorizes the text data, i.e., a textualized utterance of the training user, using TF-IDF, Word2Vec, or the like.

Subsequently, the learner 122 generates training data for training the estimation model MDL (step S206). As described above, in the utterance history information 134 including the utterances of an unspecified number of users, feedback results of the users are associated with the utterances of the unspecified number of users via user IDs. For example, it is assumed that a user associated with the positive feedback result of “accepted” in the setting of the dictionary or the utterance assistance function is selected as a training user from among an unspecified number of users. In this case, a feature quantity used for estimating the profile of the training user becomes a correct feature quantity. Accordingly, the learner 122 sets a teacher label (a label indicating the correct answer) to the feature quantity of the training user with which the positive feedback result is associated and generates a dataset in which the feature quantity of the training user as a teacher label (i.e., a correct feature quantity) is associated with the utterance of the training user with which the positive feedback result is associated as training data. That is, when the utterance of the training user associated with the positive feedback result is set as the input data and the feature quantity of the training user associated with the positive feedback result is used as the output data for the training data, a set of the input data and the output data is a dataset. Also, the training data may be a dataset in which the feature quantity of the training user as the teacher label (i.e., an incorrect feature quantity) is associated with the utterance of the training user (a vector of the utterance) with which the negative feedback result such as “rejection” or “ignorance” is associated.

Subsequently, the learner 122 trains the estimation model MDL on the basis of the training data (step S208).

FIG. 14 is a diagram schematically showing a training method of the estimation model MDL. As shown in FIG. 14, the learner 122 inputs an utterance (a vectorized utterance) of the training user corresponding to the input data of the training data to the estimation model MDL. In response to this, the estimation model MDL outputs the feature quantity of the unique utterance. The learner 122 calculates a difference Δ between the feature quantity output by the estimation model MDL and the feature quantity corresponding to the output data of the training data (a feature quantity as a teacher label associated with the output data). The difference Δ includes, for example, a gradient of a loss function or the like. The learner 122 trains the estimation model MDL so that the calculated difference Δ becomes small. Specifically, the learner 122 may determine (update) a weighting coefficient, a bias component, and the like, which are parameters of the estimation model MDL, using a stochastic gradient descent method or the like so that the difference Δ becomes small.

Description returns to the flowchart of FIG. 13. Subsequently, the learner 122 determines whether or not the number of iterations of training of the estimation model MDL has reached a specified number (step S210).

When the number of iterations of training has not reached the specified number, the learner 122 returns to the processing of S200, determines another user different from the previously selected user as a new training target, and acquires an utterance of the new training user from the utterance history information 134 including utterances of an unspecified number of users. Thereby, training data in which the utterance of the new training user and a feedback result thereof are combined is generated and the estimation model MDL is trained.

On the other hand, when the number of iterations of training has reached the specified number, the learner 122 causes the storage 230 to store the model information 138 defining the estimation model MDL that has been iteratively trained and ends the process of the present flowchart.

According to the embodiment described above, the information providing device 100 extracts a feature quantity based on a unique utterance from the utterance of the target user on the basis of the utterance history of the target user with respect to the voice user interface such as the communication terminal 300 or the agent device 500. The information providing device 100 estimates a profile of the target user on the basis of the extracted feature quantity. The profile includes indices such as a VUI proficiency level, a VUI affinity, and a dialogue affinity. The information providing device 100 determines an amount of data in the ASR dictionary or the NLU dictionary on the basis of the profile of the target user, determines an activation frequency of the utterance assistance function, or determines a continuous utterance frequency under the utterance assistance function. The information providing device 100 asks the target user to set the amount of data in the ASR dictionary or the NLU dictionary to the determined amount or set the activation frequency or the continuous utterance frequency of the utterance assistance function to the determined frequency. Thereby, it is possible to perform speech recognition and natural language understanding according to the proficiency level of each user or the like or to further perform utterance assistance at an appropriate frequency. As a result, a more user-friendly voice user interface can be implemented.

Further, according to the above-described embodiment, because the amount of data in the ASR dictionary or NLU dictionary is determined on the basis of the profile of the target user, the calculation resources related to speech recognition and natural language understanding are saved (calculation cost is reduced) or the accuracy of these processes can be improved.

The embodiment described above can be represented as follows.

An information processing device including:
a memory storing a program; and
a processor,
wherein the processor executes the program to:
extract a feature of a unique utterance from an utterance of a user on the basis of an utterance history of the user for a voice user interface; and
estimate a proficiency level of the user for the voice user interface on the basis of the extracted feature.

Although modes for carrying out the present invention have been described using embodiments, the present invention is not limited to the embodiments, and various modifications and substitutions can also be made without departing from the scope and spirit of the present invention.

What is claimed is:

1. An information processing device comprising:
an extractor configured to extract a feature of a unique utterance from an utterance of a user on the basis of an utterance history of the user for a voice user interface; and
an estimator configured to estimate a proficiency level of the user for the voice user interface on the basis of the feature extracted by the extractor.

2. The information processing device according to claim 1, wherein the feature of the unique utterance comprises a subject, a predicate, or a sentence comprised in the unique utterance.

3. The information processing device according to claim 1, wherein the feature of the unique utterance comprises a speed of the unique utterance relative to a speed of a normal utterance.

4. The information processing device according to claim 1, further comprising:
a speech recognizer configured to textualize the utterance of the user using speech recognition;
a natural language processor configured to understand a meaning of the utterance of the user textualized by the speech recognizer using natural language understanding; and
a first determiner configured to determine an amount of data in at least one of a first dictionary used in the speech recognition and a second dictionary used in the natural language understanding on the basis of the proficiency level estimated by the estimator.

5. The information processing device according to claim 4, wherein the first determiner decreases the amount of data in the first dictionary when the proficiency level is greater than or equal to a threshold value as compared with when the proficiency level is less than the threshold value.

6. The information processing device according to claim 4,
wherein the second dictionary comprises a domain dictionary in which a plurality of domains that are classification for one or more entities are mutually associated, and
wherein the first determiner increases an amount of data in the domain dictionary when the proficiency level is greater than or equal to the threshold value as compared with when the proficiency level is less than the threshold value.

7. The information processing device according to claim 4,
wherein the estimator further estimates an affinity of the user for the voice user interface on the basis of the feature extracted by the extractor, and
wherein the first determiner determines an amount of data in at least one of the first dictionary and the second dictionary on the basis of the proficiency level and the affinity estimated by the estimator.

8. The information processing device according to claim 7,
wherein the second dictionary comprises an entity dictionary in which a plurality of entities are mutually associated,
wherein the first determiner increases an amount of data in the entity dictionary in a second case where the proficiency level is greater than or equal to a first threshold value and the affinity is greater than or equal to a second threshold value as compared with a first case where the proficiency level is less than the first threshold value and the affinity is greater than or equal to the second threshold value, and
wherein the first determiner increases the amount of data in the entity dictionary in a third case where the proficiency level is less than the first threshold value and the affinity is less than the second threshold value as compared with the second case.

9. The information processing device according to claim 4, further comprising a provider configured to provide setting guidance information of a dictionary determined by the first determiner to a terminal device of the user.

10. The information processing device according to claim 1,
wherein the estimator further estimates an affinity of the user with respect to an utterance associated with the voice user interface on the basis of the feature extracted by the extractor, and
wherein the information processing device further comprises a second determiner configured to determine a frequency of assistance via an utterance of the voice user interface on the basis of the proficiency level and the affinity estimated by the estimator.

11. The information processing device according to claim 10,
wherein the second determiner increases the frequency of assistance in a second case where the proficiency level is less than a first threshold value and the affinity is greater than or equal to a second threshold value as compared with a first case where the proficiency level is greater than or equal to the first threshold value and the affinity is greater than or equal to the second threshold value, and
wherein the second determiner increases the frequency of assistance in a third case where the proficiency level is less than the first threshold value and the affinity is less than the second threshold value as compared with the second case.

12. The information processing device according to claim 10,
wherein the estimator further estimates a second affinity of the user with respect to the utterance of the voice user interface on the basis of the feature extracted by the extractor, and
wherein the second determiner determines a frequency of utterance of the voice user interface with respect to the user on the basis of the second affinity estimated by the estimator.

13. The information processing device according to claim 12, wherein the second determiner increases the frequency of utterance when the second affinity is greater than or equal to a third threshold value as compared with when the second affinity is less than the third threshold value.

14. The information processing device according to claim 10, further comprising a provider configured to provide setting guidance information of a dictionary determined by the second determiner to a terminal device of the user.

15. An information processing method comprising:
extracting, by a computer, a feature of a unique utterance from an utterance of a user on the basis of an utterance history of the user for a voice user interface; and
estimating, by the computer, a proficiency level of the user for the voice user interface on the basis of the extracted feature.

16. A computer-readable non-transitory storage medium storing a program for causing a computer to:
extract a feature of a unique utterance from an utterance of a user on the basis of an utterance history of the user for a voice user interface; and
estimate a proficiency level of the user for the voice user interface on the basis of the extracted feature.
